(19) United States
(12) Patent Application Publication
(10) Pub. No.: US 2004/0156026 A1
(43) Pub. Date: Aug. 12, 2004

(54) Exposure apparatus and exposure method

(75) Inventor: Saburo Kamiya, Ageo-shi (JP)

Correspondence Address: OLIFF & BERRIDGE, PLC, P.O. BOX 19928, ALEXANDRIA, VA, 22320, US

(73) Assignee: NIKON CORPORATION, Tokyo (JP)

(21) Appl. No.: 10/603,743

(22) Filed: Jun. 26, 2003

Related U.S. Application Data
(63) Continuation of application No. PCT/JP01/11454, filed on Dec. 26, 2001.

(30) Foreign Application Priority Data
Dec. 27, 2000 (JP) 2000-397213

(51) Int. Cl. G03B 27/52

(52) U.S. Cl. 355/30; 355/53; 355/72; 355/75

(57) ABSTRACT

A temperature adjusting unit is attached to a support member supporting a laser interferometer, and a temperature of air sent out of an air sending outlet is measured by a sensor, while a temperature of the support member is measured by a sensor, so that the temperature of the air sent and the temperature of the support member are made to coincide with each other. Thereby, the occurrence of temperature fluctuation in the optical path of detection light of the laser interferometer is suppressed.

### BACKGROUND OF THE INVENTION

1. Field of the Invention

The present invention relates to an exposure apparatus and exposure method used in the manufacturing of semiconductor integrated circuits, liquid crystal display devices, thin film magnetic heads, image picking-up devices (CCD's, etc.), other micro-devices, and the like by use of a lithography technology.

2. Description of the Related Art

In the manufacturing of micro-devices such as semiconductor devices, an exposure apparatus is used to transfer by exposure the pattern of a reticle as a mask onto a photosensitive substrate such as a semiconductor substrate or a glass plate which is coated with a photo-resist.

The photosensitive substrate is, before exposure process is performed, positioned in a plane perpendicular to the optical axis of the projection optical system with respect to an X direction and a Y direction. In addition, focus adjustment is performed where the surface of the photosensitive substrate is made to coincide with an image plane of the projection optical system.

As micro-devices become more highly integrated, positioning accuracy of several nanometers is beginning to be required of a reticle stage moving with a mask mounted thereon and a substrate stage moving with a photosensitive substrate mounted thereon.

As units that measure the positions of such highly accurate stages laser interferometers (laser length-measuring interferometers) are usually used in terms of resolution and response band range required. In such a laser interferometer, a laser beam emitted from a laser light source whose wavelength is stabilized is then divided by a beam splitter into two beams, one of which is made to irradiate a moving mirror (reflection mirror) fixed on the stage while the other beam is made to irradiate a reference mirror (reflection mirror) provided on a fixed portion such as the lens barrel of the projection optical system or the frame supporting the projection optical system, and the stage position is accurately measured from the interference signal obtained by interfering the beams reflected respectively by the mirrors.

Since this laser interferometer need make a laser beam irradiate reflection mirror provided on the side face, etc., of the table on which a wafer or a mask is mounted, there is little flexibility in the setting of the position at which the interference optical system (the laser interferometer's part placed opposite the above-mentioned reflection mirror, hereinafter also called a laser interferometer as needed) is set up, so that there is no other choice than placing it opposite horizontally to the stage.

The most significant factor of measurement error in the laser interferometer is the fluctuation of the refraction index of the optical path of the laser beam. In particular, the refraction index fluctuation due to temperature variations is the main factor, and in the case of standard air, a variation of one degree causes a variation of about 1 ppm in the refraction index. For example, even with a variation of 0.01 degrees an error of 3 nm is caused between both ends of a 300 mm wafer, posing a problem.

Further, making the surface of the photosensitive substrate coincide with an image plane of the projection optical system is performed using a oblique-incidence-type focus adjusting unit (AF unit) in which detection light having a different wavelength from the exposure light's is made to irradiate obliquely the surface of the photosensitive substrate, in which the reflected light is detected in a photoelectric manner, and by which the position in a Z-direction (direction along the optical axis of the projection optical system) and tilt of the photosensitive substrate are automatically adjusted such that the detection result coincides with a predetermined reference.

Also such the AF unit, like the above-mentioned laser interferometer, has little flexibility with respect to the set-up position, and the reduction of the accuracy due to temperature fluctuation in the optical path of the detection light need be minimized.

Therefore, in the conventional art, by sending air (gas) whose temperature has been adjusted very accurately to the optical paths of the detection light in the AF unit and the laser interferometer, the occurrence of temperature fluctuation in the optical path of the detection light is suppressed.

Although variations in the refraction index due to temperature fluctuation in the optical path of the detection light are reduced somewhat by the sending of air adjusted in temperature, temperature fluctuation in the optical path of the detection light still occurs causing a disturbance in highly accurate measurement because, the support members for supporting the laser interferometer and AF unit being necessarily present in the sent air flow, those support members are fixed to the frame supporting the projection optical system to cause the transmission of heat via the support members from the frame. Hence, a problem that patterns may not be formed very accurately is posed.

### SUMMARY OF THE INVENTION

Therefore, an object of the present invention is to provide an exposure apparatus and method that can accommodate itself to micro-devices, etc., becoming finer and more accurate with sufficiently preventing temperature fluctuation in the optical path of the detection light in the measuring unit.

According to a first aspect of the present invention, there is provided an exposure apparatus comprising a measuring unit which irradiates a measurement light beam via a measurement optical system to an object to be measured and measures information about position of the object to be measured; a holding member which holds the measurement optical system; and a temperature adjusting unit which adjusts a temperature of the holding member.

According to the exposure apparatus of the present invention, it is possible to make a temperature of the holding member and a temperature of the space where the holding member exists substantially coincide with each other. Therefore, the occurrence of errors in detecting systems such as a laser interferometer and an AF unit due to fluctuation of the temperatures is suppressed, so that movement and positioning of a mask, movement and positioning of a substrate, attitude control of those, and the like can be performed very accurately. Thus, a fine pattern can be transferred and formed very accurately, so that micro-devices and the like of high performance and high reliability come to be able to be manufactured.

The exposure apparatus according to the first aspect of the present invention may further comprise a gas supply unit which supplies gas whose temperature has been adjusted to a space including an optical path of the light beam; and a control unit which controls at least one of the temperature adjusting unit and the gas supply unit such that a temperature of gas from the gas supply unit and a temperature of the holding member coincide with each other.

The exposure apparatus according to the first aspect of the present invention may further comprise a gas supply unit which supplies gas whose temperature has been adjusted to an optical path of the light beam in a space where the object to be measured is arranged, wherein the measurement optical system and at least part of the holding member may be provided in the space. In this case, using at least one of the temperature adjusting unit and the gas supply unit, a temperature of the gas can be made to substantially coincide with a temperature of the at least part of the holding member provided in the space.

In the exposure apparatus according to the first aspect of the present invention, the object to be measured may be at least one of a mask having a pattern formed thereon, a substrate onto which the pattern is to be transferred, or both of them.

When the object to be measured is the mask or the substrate, as the measuring unit a unit may be adopted which includes an interferometer which makes the light beam irradiate a stage on which the object to be measured is mounted. In this case, the exposure apparatus may further comprise a projection optical system which projects the mask pattern onto the substrate, and as the measuring unit a unit may be adopted which includes a focus sensor which detects information about position of the object to be measured in a direction parallel to the optical axis of the projection optical system.

When the object to be measured is the mask or the substrate, the exposure apparatus may further comprise a projection optical system which projects the mask pattern onto the substrate, and as the measuring unit a unit may be adopted which includes at least one of an interferometer which makes the light beam irradiate a stage on which the object to be measured is mounted, a focus sensor which detects information about position of the object to be measured in a direction parallel to the optical axis of the projection optical system, and an alignment sensor which detects a mark on the stage. In this case, the exposure apparatus may further comprise a frame on which the projection optical system is mounted, wherein the holding member may be fixed to the frame.

As the temperature adjusting unit, a unit may be adopted which comprises a heat exchange member fixed to the holding member and a circulation unit which circulates fluid whose temperature has been adjusted in the heat exchange member.

According to a second aspect of the present invention, there is provided an exposure apparatus provided with a projection optical system which projects illumination light irradiating a first object onto a second object, the exposure apparatus comprising a frame to which the projection optical system is fixed; a measuring unit of which at least part is provided on the frame, which irradiates a measurement beam to an object to be measured and measures information about position thereof; and a temperature adjusting unit which adjusts a temperature of the part of the measuring unit provided on the frame and a holding member holding the part.

The exposure apparatus according to the second aspect of the present invention may further comprise a gas supply unit which supplies gas whose temperature has been adjusted to a space including an optical path of the measurement beam, wherein the part of the measuring unit provided on the frame is held by the holding member in the space, and wherein a temperature of the gas and a temperature of the part of the measuring unit provided on the frame and the holding member holding the part can be made to substantially coincide with each other by at least one of the temperature adjusting unit and the gas supply unit.

The object to be measured may be at least one of the first and second objects, and as the measuring unit a unit may be adopted which includes at least one of an interferometer which makes the measurement beam irradiate a stage on which one of the object to be measured is mounted, a focus sensor which detects information about position of the object to be measured in a direction parallel to the optical path of the projection optical system, and an alignment sensor which detects a mark on the stage.

In this case, the measuring unit may include at least the interferometer, and as the interferometer a unit may be adopted which detects information about the stage position in a plane orthogonal to the optical axis of the projection optical system and a relative positional relationship in a direction parallel to the optical axis between the projection optical system and the stage.

According to a third aspect of the present invention, there is provided an exposure apparatus which transfers a pattern of a first object onto a second object, the apparatus comprising a measuring unit which irradiates a measurement beam to measure information about position of the object to be measured; a gas supply unit which supplies gas whose temperature has been adjusted to a space including an optical path of the measurement beam; a holding member which holds at least part of the measuring unit in the space; and a temperature adjusting unit which makes a temperature of the gas and a temperature of one of the holding member and the at least part of the measuring unit substantially coincide with each other in the space.

In the exposure apparatus according to the third aspect of the present invention, the object to be measured may be at least one of the first and second objects, and as the measuring unit a unit may be adopted which includes an interferometer which makes the measurement beam irradiate a stage on which one of the object to be measured is mounted.

In this case, when the object to be measured is the first object or the second object, the holding member may be fixed to a frame provided separately from a base member on which the stage is arranged. Or the exposure apparatus may further comprise a projection optical system which projects a pattern of the first object onto the second object, wherein as the interferometer a unit may be adopted which detects information about the stage position in a plane orthogonal to the optical axis of the projection optical system and a relative positional relationship in a direction parallel to the optical axis between the projection optical system and the stage, or wherein as the measuring unit a unit may be adopted which includes at least one of a focus sensor which detects information about position of the object to be measured in a direction parallel to the optical axis of the projection optical system, and an alignment sensor which detects a mark on the stage.

As the temperature adjusting unit a unit may be adopted which can adjust both a temperature of the gas and a temperature of one of the holding member and the at least part of the measuring unit independently of each other.

According to a fourth aspect of the present invention, there is provided an exposure method for exposing a second object by illumination light via a first object having a pattern, comprising the steps of suppling gas whose temperature has been adjusted to a space including an optical path of a measurement beam used to measure position information of the second object, making a temperature of one of at least part of a measuring unit irradiating the measurement beam and a holding member holding the part to substantially coincide with a temperature of the gas, measuring the position information of the second object, moving the second object based on the position information measured.

In this case, the exposure method may further comprise the steps of measuring a temperature of the gas in or near an optical path of the measurement beam, and adjusting at least one of a temperature of at least part of the measuring unit or the holding member and a temperature of the gas based on the temperature measured.

### BRIEF DESCRIPTION OF THE DRAWINGS

FIG. 1 is a view showing schematically the whole construction of the exposure apparatus according to an embodiment of the present invention;

FIG. 2 is a view showing the construction of the main part of the exposure apparatus according to the embodiment of the present invention;

FIG. 3 is a view showing the construction around a laser interferometer as seen in the direction of arrow A in FIG. 2;

FIG. 4a is a plan view showing the structure of a heat sink according to the embodiment of the present invention;

FIG. 4b is a side cross-sectional view showing the structure of the heat sink according to the embodiment of the present invention; and

FIG. 5 is a view showing the construction of the temperature control system according to the embodiment of the present invention.

### DESCRIPTION OF THE PREFERRED EMBODIMENTS

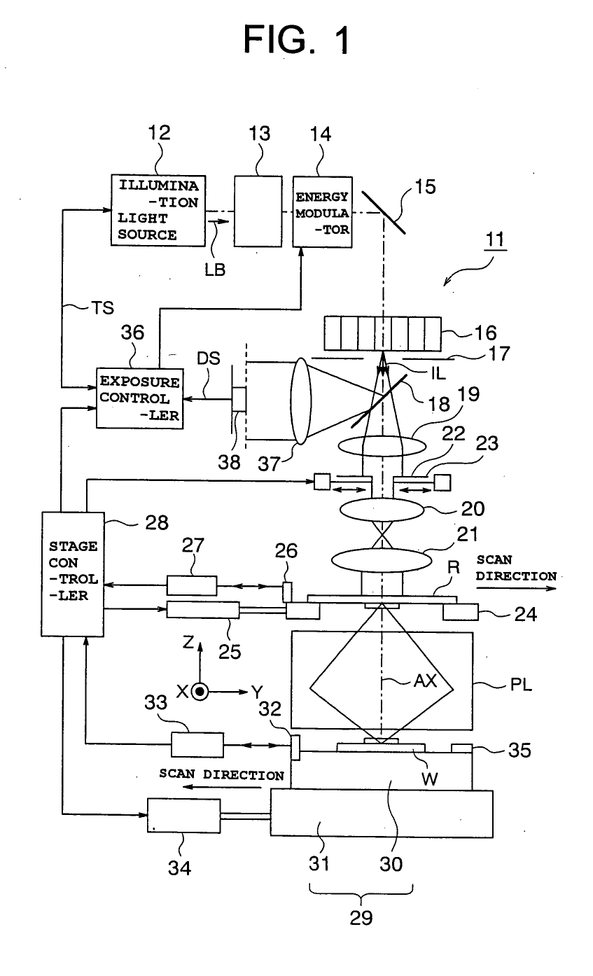

The exposure apparatus according to an embodiment of the present invention will be described below in detail with reference to the drawings. FIG. 1 is a view showing schematically the construction of the exposure apparatus according to the present embodiment. This exposure apparatus is a reducing projection exposure apparatus of a step-and-scan type.

Note that in the description below, a description will be made of a positional relationship between members with respect to an XYZ orthogonal coordinate system defined as shown in FIG. 1. In the XYZ orthogonal coordinate system, the X-axis and Y-axis are set to be parallel to the page of the drawing, and the X-axis is set to be perpendicular to the page of the drawing. In the XYZ orthogonal coordinate system in the drawing, the XY plane is, in practice, set to be parallel to the horizontal plane, and the Z-axis is set to point upward vertically.

The exposure apparatus 11 comprises as an illumination light source 12 a KrF excimer laser (a wavelength of 248 nm). A laser beam LB emitted in pulses from the illumination light source 12 is made incident on a beam shaping optical system 13. The beam shaping optical system 13 consists of a cylinder lens, a beam expander, etc., and by these elements shapes the cross-section of the beam to be efficiently incident on a fly-eye lens 16 following.

A laser beam emitted from the beam shaping optical system 13 is made incident on an energy modulator 14. The energy modulator 14 consists of an energy coarsely-adjusting unit, an energy finely-adjusting unit, and the like. The energy coarsely-adjusting unit has a plurality of ND filters, which each have a different transmittance (=(1−a light attenuation rate)×100%), arranged on a rotatable revolver. By rotating the revolver, the transmittance thereof to the incident laser beam LB can vary between a plurality of steps beginning from 100%. Note that, with two revolvers similar to that revolver arranged, the transmittance may be more finely adjusted by use of a combination of two ND filters respectively from the revolvers. On the other hand, the energy finely-adjusting unit finely adjusts the transmittance to the incident laser beam LB continuously within a predetermined range by use of a double grating method or a method using a combination of two plane-parallel plate glasses variable in the angle of tilt. Note that instead of the energy finely-adjusting unit, the energy of the laser beam LB may be finely adjusted by modulating output power of the illumination light source 12.

The laser beam LB emitted from the energy modulator 14 is made incident on the fly-eye lens 16 via a mirror 15 for deflecting the optical path. The fly-eye lens 16 forms multiple secondary illuminants to illuminate a following reticle R with uniform illuminance in distribution. Note that instead of the fly-eye lens 16 as an optical integrator (homogenizer), a rod-integrator (inner-side-reflective-type integrator) or a diffractive optical element, and the like can be used.

Arranged at the emitting surface of the fly-eye lens 16 is an aperture stop (so-called a stop) 17 for the illumination system. Laser beams (hereinafter, called illumination light IL) emitted from the secondary illuminants in the aperture stop 17 are incident on a beam splitter 18 having a low reflectance and a high transmittance, and the illumination light IL having passed through the beam splitter 18 is incident on a condenser lens 21 via a relay lenses 19, 20.

Arranged between the relay lenses 19, 20 are a fixed slit plate 22 and a reticle blind 23 having four movable blinds. The fixed slit plate 22 having a rectangular aperture, the illumination light IL having passed through the beam splitter 18 passes through the relay lens 19 and then the rectangular aperture of the fixed slit plate 22. The fixed slit plate 22 is placed near a plane conjugate to the reticle's pattern surface.

The reticle blind 23 has four movable blinds (shielding plates) movable individually and independently and is placed near the fixed slit plate 22. By moving the movable blind 23 to be set at an appropriate position before the start of scan exposure, or by moving the movable blind as needed during scan exposure, exposure of unnecessary part (other than shot areas on a wafer W onto which the reticle pattern is transferred) can be prevented.

The illumination light IL having passed through the fixed slit plate 22 and the reticle blind 23 passes through the relay lens 20 and condenser lens 21, and illuminates a rectangular illumination area on the reticle R held on a reticle stage 24 with uniform illuminance in distribution. The image of the pattern in the illumination area on the reticle R is reduced by projection magnification α (α is for example ¼, ⅕, etc.) and projected by the projection optical system PL onto a wafer (photosensitive substrate) W coated with a photo-resist.

At this time, the reticle stage 24 is scanned in the Y-axial direction by a reticle stage driving unit 25. The position of the reticle stage 24 is measured by a measuring unit 27 comprising a reflection mirror 26 fixed to the reticle stage 24, a laser interferometer, and the like. During the scan, the measuring unit 27 supplies the Y-coordinate value of the reticle stage 24 to a stage controller 28, which controls based on the supplied coordinate value the position and speed of the reticle stage 24 via the reticle stage driving unit 25. Note that the reflection mirror 26 has a reflective surface extending in the X-direction and a reflective surface extending in the Y-direction, which are not shown. Instead of the reflective surface extending in the X-direction, at least one corner-cube-type mirror may be used.

On the other hand, a wafer W is mounted via a wafer holder (not shown) on a wafer stage 29, which has a Z-stage (wafer table) 30 and an XY stage 31 on which the Z-stage 30 is mounted. Via the XY stage 31, the wafer W is positioned with respect to the X-axial direction and Y-axial direction, and is scanned in the Y-axial direction.

The Z-stage 30 has a function that the position in the Z-axial direction of the wafer W (focus position) and the tilt angle of the wafer W to the XY-plane are adjusted. The position of the wafer stage 29 is measured by a measuring unit 33 comprising a reflection mirror 32 fixed to the Z-stage 30, a laser interferometer, and the like. The measuring unit 33 supplies the X-coordinate and Y-coordinate values of the wafer stage 29 (wafer W) to the stage controller 28, which controls based on the supplied coordinate values the position and speed of the XY stage 31 via a wafer stage driving unit 34. Note that the reflection mirror 32 has a reflective surface extending in the X-direction and a reflective surface extending in the Y-direction, which are not shown.

The operation of the stage controller 28 is controlled by a main control system (not shown) controlling the whole apparatus overall. And during scan exposure, the reticle R is scanned at a speed of V_{R} in the +Y axial direction (or −Y axial direction) via the reticle stage 24, while synchronously scanning the wafer W via the XY stage 31 in the −Y (or +Y axial direction) at speed α×V_{R} (α is the projection magnification from reticle R to wafer W).

An illuminance distribution sensor 35 constituted by photoelectric conversion elements is fixed near the wafer W on the Z-stage 30, and the light receiving surface of the illuminance distribution sensor 35 is set to be at the same height as the surface of the wafer W. As the illuminance distribution sensor 35, a PIN-type photo-diode, etc., which is sensitive to light in the far ultraviolet range and has a high response frequency to detect the illumination light IL can be used. The detected signal of the illuminance distribution sensor 35 is supplied to an exposure controller 36 via a peak-hold circuit (not shown) and an analog/digital (A/D) converter.

The illumination light IL reflected by the beam splitter 18 is received through a condenser lens 37 by an integrator sensor 38 constituted by photoelectric conversion elements, and the photoelectrically converted signal of the integrator sensor 38 is supplied as an output DS to the exposure controller 36 via the peak-hold circuit (not shown) and the analog/digital converter. The correlation coefficient between the output DS of the integrator sensor 38 and the illuminance (exposure amount) of the illumination light IL on the surface of the wafer W is obtained beforehand and stored in the exposure controller 36. The exposure controller 36, by supplying control information TS to the illumination light source 12, controls the light-emission timing, light-emission power, etc., of the illumination light source 12. The exposure controller 36 further controls the light attenuation rate in the energy modulator 14, and the stage controller 28 controls the open and close operation of the reticle blind 23 according to operation information of the stage system.

While, in the above exposure apparatus, the reflection mirrors 26, 32 constructing part of the measuring units 27, 33 for the reticle stage 24 and the wafer stage 29 are fixed to the stages 24, 30, such mirrors may be formed by for example mirror-processing end faces of the stages. While FIG. 1 illustrates that the measuring unit 33 including the reflection mirror 32 measures the position in the Y-axial direction, an identical one is provided for the X-axial direction as well.

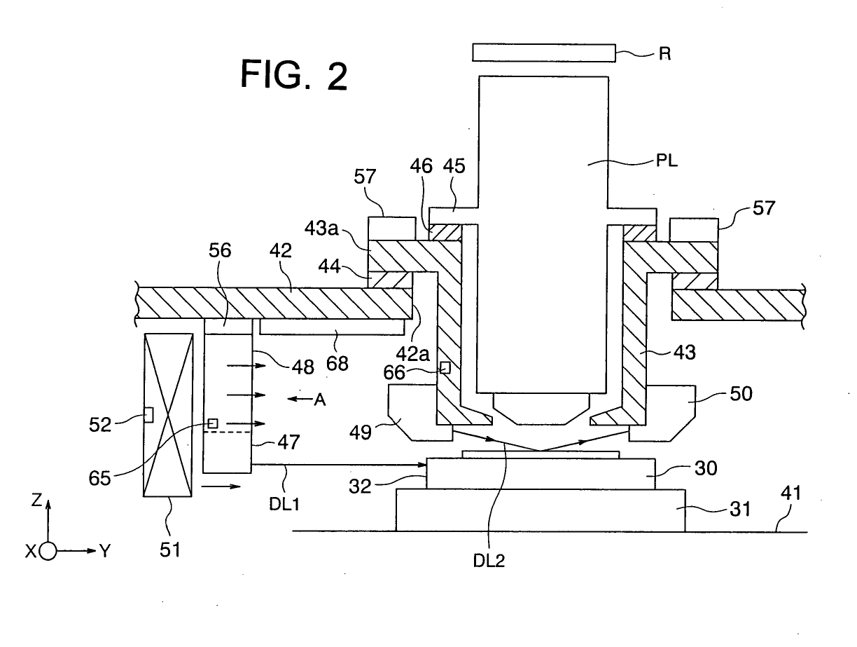

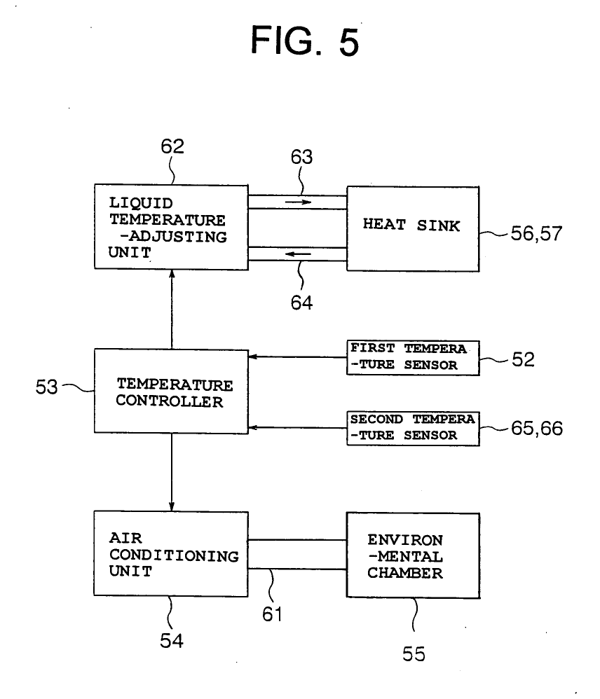

Next, with reference to FIG. 2, the construction of the main part of the exposure apparatus according to the present embodiment will be described. The main part (reticle R, the projection optical system PL, a portion where wafer W is placed, and part of the illumination optical system) of this exposure apparatus is housed in an environmental chamber (temperature-controlling chamber; not shown). The environmental chamber (55 in FIG. 5) is a box-like body having a top plate and side plates that is a unit for achieving a better environment than in a clean room where this exposure apparatus is placed.

A frame 42 is provided inside the environmental chamber, and the horizontal portion (division wall portion) of the frame 42 divides the environmental chamber's inner space into an upper space (reticle room) and a lower space (wafer room).

The environmental chamber prevents particles such as dust from sticking to the units and controls temperatures in the inner space of the environmental chamber so as to keep them within a predetermined temperature range. Inside the environmental chamber temperatures are more accurately controlled than in a usual clean room. For example, while temperatures in a clean room are controlled to be kept within the range of ±2° C. to ±3° C., temperatures in the environmental chamber are kept within the range of about ±0.1° C. Note that the frame 42 is arranged via a vibration isolation mechanism (not shown) on the floor of the clean room or a frame caster. And a base member 41 on which the XY stage 31 is placed is arranged via a vibration insulation mechanism (not shown) on the floor or the frame caster, or suspended from the frame 42 via a fixing member (not shown).

A through hole 42a is formed through the horizontal portion of the frame 42, and a substantially cylinder-like support member 43 having an annular flange portion 43a is so arranged as to protrude through the through hole 42a. The support member 43 is a member for a supporting AF unit 49, 50 (not shown in FIG. 1) described later, and is fixed via an annular spacing member 46 to the frame 42.

The projection optical system PL is fixed to the support member 43 with its being inserted in the support member 43. The projection optical system PL has an annular flange portion 45 on the periphery of its lens barrel and near the center in the optical axis direction and, with part below it being inserted in the support member 43, is fixed to the annular flange portion 43a of the support member 43 via an annular spacing member 46.

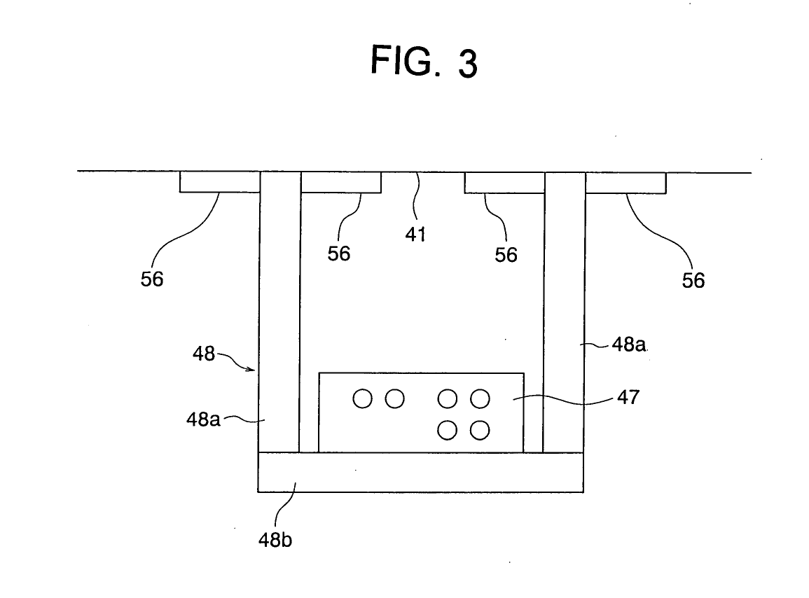

The measuring unit 33 (see FIG. 1) measuring the position of the wafer stage 29 (wafer W) comprises a laser interferometer (interference optical system) 47, and this laser interferometer is fixed in a suspended state via a support member 48 such that it is positioned at a predetermined position below the horizontal portion of the frame 42. The support member 48, as shown in FIG. 3, is a member having a pair of side plates 48a and a bottom plate 48b, and on the bottom plate 48b the laser interferometer 47 is mounted. Note that while the laser interferometer 47 for measuring the position in the Y-axial direction is shown, a laser interferometer for measuring the position in the X-axial direction is also arranged in the same way as the laser interferometer 47.

The laser interferometer 47 is a unit where a laser beam emitted from a laser light source whose wavelength is stabilized is then divided by a beam splitter into two beams, one beam (detection light) DL1 of which is made to irradiate the reflection mirror 32 of the Z-stage 30, while the other beam (reference light) is made to irradiate a reference mirror (not shown) provided on a fixed portion such as the projection optical system, and where the Z-stage's position in the X- or Y-axial direction is accurately measured from the interference signal obtained by interfering the beams reflected respectively by the mirrors.

Note that in order to improve the measurement accuracy of the laser interferometer 47, by measuring the length of a reference member that hardly expands due to heat by a laser interferometer for correction adjacently placed and correcting the measurement results of the laser interferometer for measurement based on the difference between the apparent dimension of the reference member measured by the laser interferometer for correction and the absolute dimension of the reference member, an error due to the variation of the refraction index in the optical path may be corrected. Further, the present invention may be applied to a laser interferometer having such a structure to obtain the same effect.

An AF (Auto Focus) unit for making the surface of a wafer W coincide with an image plane of the projection optical system comprises a light sending optical system 49 which makes detection light DL2 for AF irradiate obliquely the surface of the wafer W, and a light receiving optical system 50 which receives detection light DL2 reflected by the surface of the wafer W. The light sending optical system 49 and the light receiving optical system 50, as shown in FIG. 2, are fixed near the top of the supporting member 43.

The light sending optical system 49 comprises a light emission portion emitting broad-band light whose wavelengths range from red to infrared, and besides, a slit, a lens, a mirror, an aperture stop, and the like, and projects detection light DL2 defined like a slit obliquely to the surface of the wafer W. At this time, the slit is imaged on the wafer W. Detection light DL2 reflected from the slit image is incident on the light receiving optical system 50 comprising a fixed mirror, a lens, a vibrating mirror, a plane-parallel plate glass variable in angle, a slit for detection, a photo-multiplier for detecting photoelectrically the beam of the slit image passing through the slit, and the like.

The detected signal outputted by the light receiving optical system 50 is usually set to be at a zero level when the surface of the wafer W coincides with the best focus of the projection optical system PL, and the signal is an analog signal which is at a positive level, when the wafer W is displaced from it upward along the optical axis AX, and at a negative level, when displaced in the opposite direction. An AF controller (not shown) can automatically achieve focusing on the wafer W by driving an actuator to displace the Z-stage 30 as needed.

And the environmental chamber of this exposure apparatus is provided with a side-flow-type air conditioning system. This air conditioning system is structured to have an air-sending outlet 51 connected with an air-sending duct (not shown) and a discharge inlet (not shown) connected with a discharge duct, and the air-sending outlet 51 is provided extending vertically in the environmental chamber's lower space (wafer room), and an air flow is blown out of the air-sending outlet 51 along the direction (horizontal direction) almost perpendicular to the optical axis of the projection optical system PL. Note that while in this embodiment the air conditioning system of the environmental chamber is of the side flow type, for example a down flow type may be used. In this case, the air-sending outlet 51 may be formed in the lower surface of the frame 42, and, as needed, the air-sending duct (not shown) may be made to divide so that another air-sending outlet for sending an air flow into between the projection optical system PL and the wafer W is formed.

This air conditioning system is provided with an HEPA (or ULPA) filter and chemical filter for removing foreign objects (dust), sulfuric acid ions, ammonia ions, etc., which are floating in the clean room, and prevents such foreign objects from entering the inside of the environmental chamber.

An air flow blown from the air-sending outlet 51 flows in the horizontal direction, and is discharged to the outside through the discharge inlet (not shown) formed extending vertically in the side wall opposite the air-sending outlet 51 of the environmental chamber's lower space.

A first temperature sensor 52 detecting the temperature of air supplied from the air-sending outlet 51 is provided near the air-sending outlet 51, and as shown in FIG. 5, the detection result of the first temperature sensor 52 is inputted into a temperature controller 53 constituted by a microcomputer, etc.; the temperature controller 53 controls an air conditioning unit 54 based on the detection result of the first temperature sensor 52 to adjust the temperature of air to be sent. In FIG. 5, reference numerals 55 and 61 indicate the environmental chamber and the air-sending duct.

In FIG. 2, air sent from the air-sending outlet 51 flows from behind the laser interferometer 47 along the optical path of the detection light DL1 from the laser interferometer 47, passes through the space between the wafer W and the projection optical system PL, which the space includes the optical path of the detection light DL2 of the AF unit 49, 50, and is discharged through the discharge inlet (not shown). Most of discharged air is returned via a chemical filter, etc., to the air conditioning unit 54, and is circulated in the environmental chamber 55.

Here, if heat from heating elements such as printed circuit board, etc., provided on the frame 42 is transmitted through the frame 42 to the support member 48 of the laser interferometer 47 or the support member 43 of the AF unit 49, 50, temperatures around the support member 43 or 48 rise even with the air conditioning unit 54 sending air, so that temperature fluctuation may occur in the optical path of the detection light DL1 of the laser interferometer 47, the optical path of the detection light DL2 of the AF unit 49, 50.

Hence, the present embodiment takes the following measures. As shown in FIGS. 2 and 3, a plurality of heat sinks (heat exchange member) 56 are fixed to the frame-42-side end of the support member 48 supporting the laser interferometer 47. In this embodiment, each of the pair of side plates 48a of the support member 48 are sandwiched between two heat sinks, a total of four heat sinks being fixed.

Further, a plurality of heat sinks 57 are fixed to the flange portion 43a of the support member 43 supporting the AF unit 49, 50. The plurality of heat sinks 57 are fixed at predetermined angular pitches. Note that they may be a single one formed to be annular.

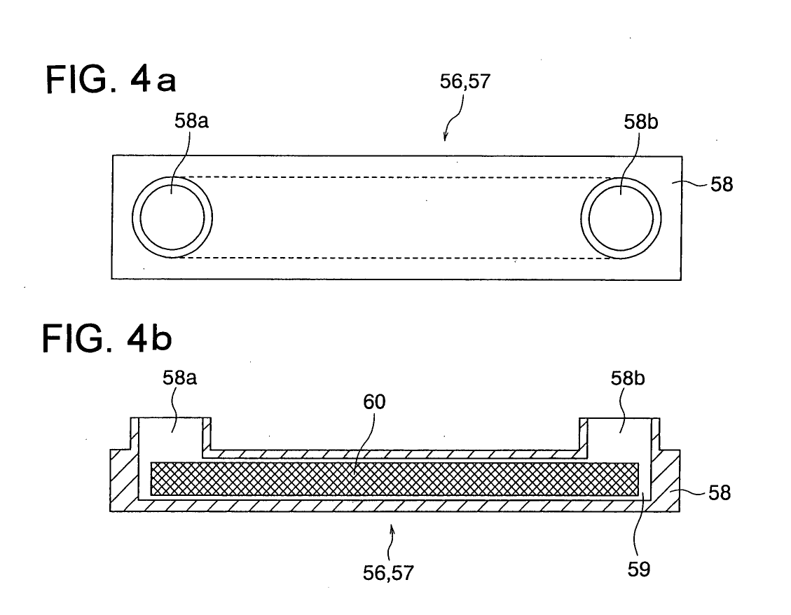

The structures of the heat sinks 56, 57 are shown in FIGS. 4a and 4b. The heat sinks 56, 57 of this embodiment are each constituted by a block 58 made of a material good in thermal conductivity such as aluminum or copper, in which block 58 a flow passage 59 is formed through which a temperature adjusting liquid flows. Formed in the block 58 are a liquid supply inlet 58a for supplying liquid into the flow passage 59 and a liquid discharge outlet 58b for discharging liquid from the flow passage 59. A thermal conductor 60 such as a porous body of metal or a fin array which also promotes turbulence is provided in the flow passage 59 to minimize heat resistance between the liquid and the block 58. In FIG. 4, the lower surface opposite to the surface where the liquid supply inlet 58a and the liquid discharge outlet 58b are formed is an attaching surface.

The liquid supply inlet 58a and the liquid discharge outlet 58b of these heat sinks 56, 57 are, as shown in FIG. 5, connected with pipes 63, 64 individually connected to a liquid temperature-adjusting unit 62, and liquid whose temperature has been adjusted is supplied from the liquid temperature-adjusting unit 62. And the liquid exchanges heat with the support members 43, 48 via the heat sinks 56, 57, and returns to the liquid temperature-adjusting unit 62. The circulated liquid is not limited to any and for example Fluorinert (product name) can be used.

Note that while, needless to say, the heat sinks 56, 57 can be individually connected by pipes, in parallel, to the liquid temperature-adjusting unit 62 to circulate and supply liquid independently, all or part of each of the groups of heat sinks 56, 57 may be connected in series by pipes to circulate and supply liquid through the series. In this embodiment, there are provided a first liquid circulation system where a plurality of heat sinks 56 are connected in series for the support member 48 for the liquid temperature-adjusting unit 62 to supply liquid through the series of the heat sinks 56; and a second liquid circulation system where a plurality of heat sinks 57 are connected in series for the support member 43 for the liquid temperature-adjusting unit 62 to supply liquid through the series of the heat sinks 57. In this case, the liquid temperature-adjusting unit 62 can adjust the temperature of the liquid for each system.

Provided for the respective support members 43, 48 are second temperature sensors 65, 66 for detecting temperatures of the support members 43, 48, and detection results of the second temperature sensors 65, 66 are inputted into the temperature controller 53. The temperature controller 53, based on the detection results of the temperature sensors 65, 66, controls the liquid temperature-adjusting unit 62 to adjust the temperatures of the liquid to be supplied. The temperature sensor 65, 66 may be fixed to heat sinks 56, 57 instead of the support members 43, 48.

The temperature controller 53 controls the air conditioning unit 54 such that the temperature of sent air detected by the first temperature sensor 52 provided near the air-sending outlet 51 is equal to a predetermined temperature (e.g. 20° C.) and also controls the liquid temperature-adjusting unit 62 such that the temperatures of the support members 43, 48 detected by the second temperature sensors 65, 66 fixed to the support members 43, 48 are equal to the predetermined temperature (e.g. 20° C.).

Note that the control of the air conditioning unit 54 and the liquid temperature-adjusting unit 62 by the temperature controller 53 being not limited to the above, it may control the air conditioning unit 54 such that the temperature of sent air detected by the first temperature sensor 52 is equal to a predetermined temperature (e.g. 20° C.) and also control the liquid temperature-adjusting unit 62 such that the temperatures of the support members 56, 57 detected by the second temperature sensors 65, 66 coincide with the temperature of the sent air detected by the first temperature sensor 52. Oppositely, the temperature controller 53 may control the liquid temperature-adjusting unit 62 such that the temperatures of the support members 43, 48 detected by the second temperature sensors 65, 66 are equal to a predetermined temperature (e.g. 20° C.), and also control the air conditioning unit 54 such that the temperature of sent air detected by the first temperature sensor 52 coincides with the temperatures of the support members 43, 48 detected by the second temperature sensors 65, 66.

Alternatively, it may be that temperature sensors identical to the first temperature sensor 52 for detecting the temperature of sent air are provided near the optical path of the detection light DL1 of the laser interferometer 47 and near the optical path of the detection light DL2 of the AF unit 49, 50 to detect the temperatures of air flowing there, and the temperature controller 53, based on these detection results, performs the same control as in the above. In this case, the temperature controller 53 may, based on the detection result of the temperature sensor provided near the optical path of the detection light DL1, control the liquid's temperature in the first liquid circulation system by the liquid temperature-adjusting unit 62 and, based on the detection result of the temperature sensor provided near the optical path of the detection light DL2, control the liquid's temperature in the second liquid circulation system by the liquid temperature-adjusting unit 62. That is, the temperatures of the support members 43, 48 can be arranged to be controlled independently of each other.

Note that in FIG. 2, the reference numeral 68 indicates a heat insulating member which is fixed to the surface, on the wafer room side, of the frame 42 in order to prevent the emission of heat from the surface of the frame 42, which would otherwise be exposed, into the wafer room.

According to the present embodiment, the temperature of sent air from the air-sending outlet 51, that is, the temperature of the neighborhood of the support members 43, 48 substantially coincides with the temperature of the support members 43, 48, so that temperature fluctuation (dynamic variations of the refraction index) in the optical path of the detection light DL1 of the laser interferometer 47 and the optical path of the detection light DL2 of the AF unit 49, 50 is suppressed. Therefore, the accuracy of the detected values of the laser interferometer 47 and the AF unit 49, 50 can be improved.

Thus, the positioning with respect to the X- and Y-directions and scan movement of a wafer W, making the surface of the wafer W to coincide with the image plane of the projection optical system, and the like can be performed precisely, and thereby the accuracy in transferring and forming a pattern on the wafer W can be improved, so that micro-devices and the like of high performance and high reliability come to be able to be manufactured.

The embodiment described above is provided to facilitate the understanding of the present invention and not intended to limit the present invention to the details shown. Therefore, it should be understood that various changes, substitutions and alterations can be made within the spirit and scope of the present invention.

Although the above embodiment describes as a temperature adjusting unit that adjusts the temperatures of the support members 43, 48 a unit comprising the liquid temperature-adjusting unit 62 and the heat sinks 56, 57, it need only be able to cool and heat the support members 43, 48. For example, Peltier devices generating and absorbing heat due to the Peltier effect can be used, and may be used in combination with the heat sinks.

Although the above embodiment describes an example where the present invention is applied to the wafer room below the horizontal portion of the frame 42 in the environmental chamber, because the same problem due to temperature fluctuation can occur also with the optical path of the detection light of the laser interferometer of the measuring unit 27 for measuring the position of the reticle stage 24, the present invention is preferably applied to the upper portion, the reticle room as well. Further, as to a reticle R, the position, in the direction of the optical axis of the projection optical system PL, tilt and the like of its pattern surface may also be measured like with the wafer W, in which case because for example an AF unit identical to the AF unit 49, 50 or a laser interferometer is used, the present invention is preferably applied thereto. Further, in a case where the base member 41 on which the XY stage 31 is arranged is provided apart from the frame 42, because a laser interferometer or the like, which makes laser beams irradiate a reflective surface provided on the lower surface of the frame 42 and a reflective surface fixed at an angle of 45 degrees to the Z-stage 30, is used in order to detect the relative positional relationship (distance in the direction of the optical axis of the projection optical system PL) between the frame 42 (the projection optical system PL) and the Z-stage 32, the present invention is preferably applied thereto likewise. Yet further, because at least part of especially the optical system of an off-axis-type alignment system that detects alignment marks on a wafer is fixed to the frame 42 via a piece of hardware, the present invention is preferably applied thereto likewise. Still further, while in the above embodiment air whose temperature has been controlled is sent to the optical paths of the laser interferometers and the like, the present invention is preferably applied likewise to a case where for example inert gas such as nitrogen or helium whose temperature and pressure have been adjusted is supplied to the wafer room or the reticle room, that is, the inside is purged with the inert gas.

While in the above-described embodiment, gas supplied to the inside of the environmental chamber is air, other gas may be used instead. In particular when the light source is one emitting far ultraviolet light, nitrogen or helium is preferably used in order to prevent the absorption by oxygen in air.

While the above embodiment describes a step-and-scan-type reducing projection exposure apparatus to which the present invention has been applied, it can be applied to any types of exposure apparatuses such as reducing projection exposure apparatuses of a step-and-repeat type and a step-and-stitching type, and mirror projection aligners.

This invention can be applied not only to an exposure apparatus for manufacturing semiconductor devices or liquid display devices but also to an exposure apparatus for producing plasma displays, thin-film magnetic heads, image pickup devices (CCD's, etc.), micro machines, DNA chips, or the like and to an exposure apparatus that transfers a circuit pattern onto a glass substrate, a silicon wafer, or the like to produce a reticle or a mask. That is, the present invention can be applied regardless of the exposure type and usage of exposure apparatus.

Although in the above embodiment a KrF excimer laser having a wavelength of 248 nm is used as the exposure light source, not being limited to this, a g-line (a wavelength of 436 nm), an i-line (a wavelength of 365 nm), an ArF excimer laser (a wavelength of 193 nm), an F₂ laser (a wavelength of 157 nm), an Ar₂ laser (a wavelength of 126 nm), or the like can be adopted. X-rays (including EUV light) or a charged-particle beam such as an ion beam or electron beam can also be used. Alternatively, a harmonic generator such as a YAG laser or semiconductor laser may be used. For example, a harmonic may be used which is obtained with wavelength conversion into ultraviolet by using non-linear optical crystal after having amplified a single wavelength laser light, infrared or visible, emitted from a DFB semiconductor laser device or a fiber laser by a fiber amplifier having, for example, erbium (or erbium and ytterbium) doped. Note that as a single wavelength oscillation laser an ytterbium-doped-fiber laser is used.

In exposure apparatuses using an F₂ laser as the light source, for example all refractive optical members (lens elements) used in the illumination optical system and the projection optical system are made of fluorite, and air in the environmental chamber, the illumination optical system and the projection optical system is replaced with for example helium gas. And used as reticles are ones made of fluorite, fluorine-doped synthetic quartz, magnesium fluoride, LiF, LaF₃, lithium-calcium-aluminum-fluoride (LiCaAlF crystal), quartz, or the like.

The projection optical system is not limited to a reduction system, and may also be an equal magnification system or an enlargement system. Further, the projection optical system is not limited to a dioptric system, and may also be a cata-dioptric system or a catoptric system.

An exposure apparatus of the present embodiment can be made in the following manner. The illumination optical system and the projection optical system, which are constituted of a plurality of lenses, are built in the exposure main body, and optical adjustment is performed thereon; the reticle stage and the substrate stage that consist of multiple mechanical parts are installed in the exposure main body, and are connected with electric wires and pipes; the laser interferometers and the AF unit are installed, and to their support members the heat sinks and temperature sensors are fixed and connected with electric wires and pipes, and optical adjustment is performed; the environmental chamber having the air conditioning unit is separately built, and the exposure main body is installed in the environmental chamber; and overall adjustment (electrical adjustment, operation check and the like) is performed. Note that the exposure apparatus is preferably made in a clean room where temperature, cleanliness and the like are controlled.

In the manufacture of devices (semiconductor chips such as ICs or LSIs, liquid crystal display panels, CCD's, thin-film magnetic heads, micro machines, or the like) using the exposure apparatus according to the embodiment of the present invention, first, in a design step, function design for the devices (e.g., circuit design for semiconductor devices) is performed and pattern design is performed to implement the function. Subsequently, in a mask producing step, masks on which the designed circuit pattern is formed are produced. Meanwhile, in a wafer manufacturing step, wafers are manufactured by using silicon material or the like.

Next, in a wafer process step, actual circuits and the like are formed on the wafers with a lithography technology using the masks and the wafers prepared in the above steps. Next, in an assembly step, the individual devices are assembled from the wafers having been processed in the wafer process step. The assembly step includes processes such as an assembly process (dicing and bonding) and a packaging process (chip encapsulation). Finally, in an inspection step, an operation test, a durability test, and the like are performed on the devices having been assembled in the assembly step. After these steps, the devices are finished and shipped out.

According to the present invention, because the temperatures of the support members can be made to coincide with the temperatures of the space around the support members, errors due to temperature fluctuation of detectors such as the laser interferometers and the AF unit in the exposure apparatus are suppressed, so that the positioning of a mask, the positioning and attitude control of a substrate, and synchronous movement of the mask and substrate can be performed very accurately. Thus, a fine pattern can be transferred and formed very accurately, so that an effect that micro-devices and the like of high performance and high reliability can be manufactured is obtained.

The present disclosure relates to the subject matter of Japanese Patent Application No. 2000-397213, filed on Dec. 27, 2000, the disclosure of which is expressly incorporated herein by reference in its entirety.

1. An exposure apparatus comprising:
a measuring unit which irradiates a measurement light beam via a measurement optical system to an object to be measured and measures information about position of the object to be measured;
a holding member which holds the measurement optical system; and
a temperature adjusting unit which adjusts a temperature of the holding member.

2. An exposure apparatus according to claim 1, further comprising:
a gas supply unit which supplies gas whose temperature has been adjusted to a space including an optical path of the light beam; and
a control unit which controls at least one of the temperature adjusting unit and the gas supply unit such that a temperature of gas from the gas supply unit and a temperature of the holding member coincide with each other.

3. An exposure apparatus according to claim 1, further comprising:
a gas supply unit which supplies gas whose temperature has been adjusted to an optical path of the light beam in a space where the object to be measured is arranged,
wherein the measurement optical system and at least part of the holding member are provided in the space.

4. An exposure apparatus according to claim 3, wherein using at least one of the temperature adjusting unit and the gas supply unit, a temperature of the gas is made to substantially coincide with a temperature of the at least part of the holding member provided in the space.

5. An exposure apparatus according to claim 1, wherein the object to be measured is at least one of a mask having a pattern formed thereon and a substrate onto which the pattern is to be transferred.

6. An exposure apparatus according to claim 5, wherein the measuring unit includes an interferometer which irradiates the light beam to a stage on which the object to be measured is mounted.

7. An exposure apparatus according to claim 6, further comprising:
a projection optical system which projects the mask pattern onto the substrate,
wherein the measuring unit includes a focus sensor which detects information about position of the object to be measured in a direction parallel to an optical axis of the projection optical system.

8. An exposure apparatus according to claim 5, further comprising:
a projection optical system which projects the mask pattern onto the substrate,
wherein the measuring unit includes at least one of an interferometer which irradiates the light beam to a stage on which the object to be measured is mounted, a focus sensor which detects information about position of the object to be measured in a direction parallel to an optical axis of the projection optical system, and an alignment sensor which detects a mark on the stage.

9. An exposure apparatus according to claim 8, further comprising:
a frame on which the projection optical system is mounted,
wherein the holding member is fixed to the frame.

10. An exposure apparatus according to claim 5, wherein the temperature adjusting unit comprises a heat exchange member fixed to the holding member and a circulation unit which circulates fluid whose temperature has been adjusted in the heat exchange member.

11. An exposure apparatus provided with a projection optical system which projects illumination light irradiating a first object onto a second object, the exposure apparatus comprising:
a frame to which the projection optical system is fixed;
a measuring unit of which at least part is provided on the frame, which irradiates a measurement beam to an object to be measured and measures information about position thereof; and
a temperature adjusting unit which adjusts a temperature of the part of the measuring unit provided on the frame and a holding member holding the part.

12. An exposure apparatus according to claim 11, further comprising:
a gas supply unit which supplies gas whose temperature has been adjusted to a space including an optical path of the measurement beam,
wherein the part of the measuring unit provided on the frame is held by the holding member in the space, and wherein a temperature of the gas and a temperature of the part of the measuring unit provided on the frame and the holding member holding the part are made to substantially coincide with each other by at least one of the temperature adjusting unit and the gas supply unit.

13. An exposure apparatus according to claim 12, wherein the object to be measured is at least one of the first and second objects, and wherein the measuring unit includes at least one of an interferometer which irradiates the measurement beam to a stage on which the object to be measured is mounted, a focus sensor which detects information about position of the object to be measured in a direction parallel to an optical axis of the projection optical system, and an alignment sensor which detects a mark on the stage.

14. An exposure apparatus according to claim 13, wherein the measuring unit includes at least the interferometer, and the interferometer detects position information of the stage in a plane orthogonal to the optical axis of the projection optical system and a relative positional relationship in a direction parallel to the optical axis between the projection optical system and the stage.

15. An exposure apparatus which transfers a pattern of a first object onto a second object, the apparatus comprising:
a measuring unit which irradiates a measurement beam and measures information about position of an object to be measured;
a gas supply unit which supplies gas whose temperature has been adjusted to a space including an optical path of the measurement beam;
a holding member which holds at least part of the measuring unit in the space; and
a temperature adjusting unit which makes a temperature of the gas and a temperature of one of the holding member and the at least part of the measuring unit substantially coincide with each other in the space.

16. An exposure apparatus according to claim 15, wherein the object to be measured is at least one of the first and second objects, and wherein the measuring unit includes an interferometer which irradiates the measurement beam to a stage on which one of the object to be measured is mounted.

17. An exposure apparatus according to claim 16, wherein the holding member is fixed to a frame provided separately from a base member on which the stage is arranged.

18. An exposure apparatus according to claim 16, further comprising:
a projection optical system which projects a pattern of the first object onto the second object,
wherein the interferometer detects information about a position of the stage in a plane orthogonal to an optical axis of the projection optical system and a relative positional relationship in a direction parallel to the optical axis between the projection optical system and the stage.

19. An exposure apparatus according to claim 16, further comprising:
a projection optical system which projects a pattern of the first object onto the second object,
wherein the measuring unit includes at least one of a focus sensor which detects information about position of the object to be measured in a direction parallel to an optical axis of the projection optical system, and an alignment sensor which detects a mark on the stage.

20. An exposure apparatus according to claim 16, wherein the temperature adjusting unit can adjust both a temperature of the gas and a temperature of one of the holding member and the at least part of the measuring unit independently of each other.

21. An exposure method for exposing a second object by illumination light via a first object having a pattern, comprising the steps of:
suppling gas whose temperature has been adjusted to a space including an optical path of a measurement beam used to measure position information of the second object,
making a temperature of one of at least part of a measuring unit irradiating the measurement beam and a holding member holding the part to substantially coincide with a temperature of the gas,
measuring the position information of the second object,
moving the second object based on the measured position information.

22. An exposure method according to claim 21, further comprising the steps of:
measuring a temperature of the gas in or near an optical path of the measurement beam, and
adjusting at least one of a temperature of at least part of the measuring unit or the holding member and a temperature of the gas based on the measured temperature.
